(19) United States
(12) Patent Application Publication
(10) Pub. No.: US 2008/0174658 A1
(43) Pub. Date: Jul. 24, 2008

(54) High speed photography system for producing 3D still pictures and movies

(76) Inventors: David E. Santus, Pawling, NY (US); Randall E. McCoy, Little Falls, NJ (US); J. Roy Nelson, Pennington, NJ (US)

Correspondence Address: TOD R NISSLE, PO BOX 55630, PHOENIX, AZ, 85078, US

(21) Appl. No.: 11/656,911

(22) Filed: Jan. 23, 2007

(51) Int. Cl. G06T 15/00

(52) U.S. Cl. 348/47; 348/E13.074

(57) ABSTRACT

A system produces three dimensional pictures of a selected viewable face of at least one object. The system includes at least one high speed digital camera positioned to receive light traveling along a path generally parallel to the viewable face of the object; a plurality of mirrors each positioned at a different location to receive light traveling away from the viewable face of the object and to reflect the light along the path toward the camera; and, a plurality of shutters each operatively associated with a different one of the mirrors to open in a selected sequence to permit light from the object to pass through the shutter to be reflected off the shutter's operatively associated mirror along the path toward the camera to produce an image in the camera.

This invention relates to photography.

More particularly, the invention relates to a system for producing three dimensional photographs in the form of still pictures or motion pictures.

Three-dimensional (3D) photography currently uses a lenticular camera “track” apparatus that includes a fixed track, a carriage that moves along the track, and a camera mounted on the carriage to move along the track simultaneously with the carriage. The track is spaced apart from the object being photographed such that when the carriage and camera move along the track, the camera is generally normal to the object. The camera includes a body, either film or an electron image storage system in the body, a controllable shutter mounted on the body, and a focusable lens assembly mounted on the body. The camera typically photographs the object when the carriage, and camera, is at six to ten different, spaced-apart, positions along the fixed track. These six to ten photographs are then assembled with a computer program to produce a three dimensional photograph. A lenticular lens is placed in front of the photograph in order to view the photograph.

One disadvantage of the conventional track apparatus described above is that the speed with which the carriage and camera can, practically speaking, be moved along the track is limited.

Another disadvantage of the conventional track apparatus is that the resolution of photographs produced is limited, particularly if the object being photographed is moving.

A further disadvantage of the conventional track apparatus is that six to ten cameras are required to photograph a moving object, which makes acquiring, utilizing, and maintenancing the apparatus unduly expensive.

It would be highly desirable, therefore, to provide an improved photograph system to produce three dimensional still pictures and motion pictures.

Accordingly, it is an object of the present invention to provide an improved photography system.

A further object of the invention is to provide a photography system that can be utilized to produce three dimensional still pictures and motion pictures.

These and other, further and more specific objects and advantages of the invention will be apparent to those skilled in the art from the follow detailed description thereof, taken in conjunction with the drawings, in which:

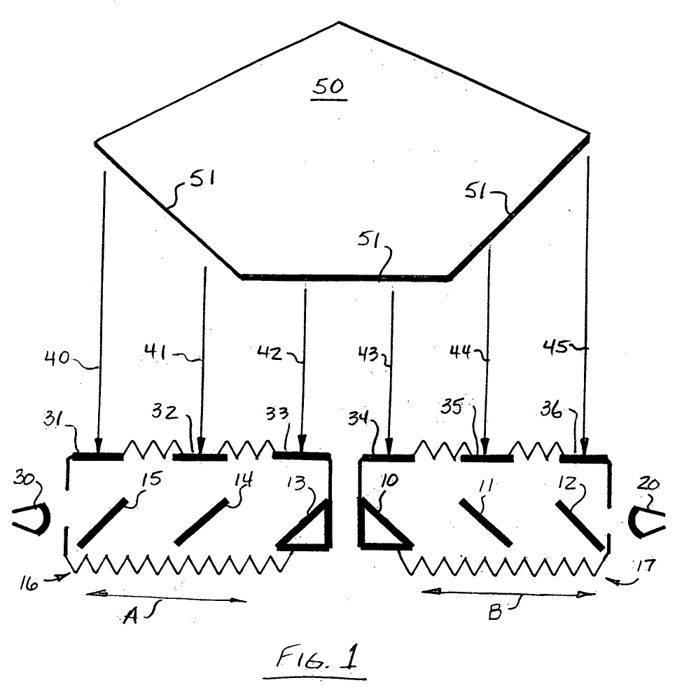

FIG. 1 is a diagram illustrating a photography system constructed in accordance with the principles of the invention;

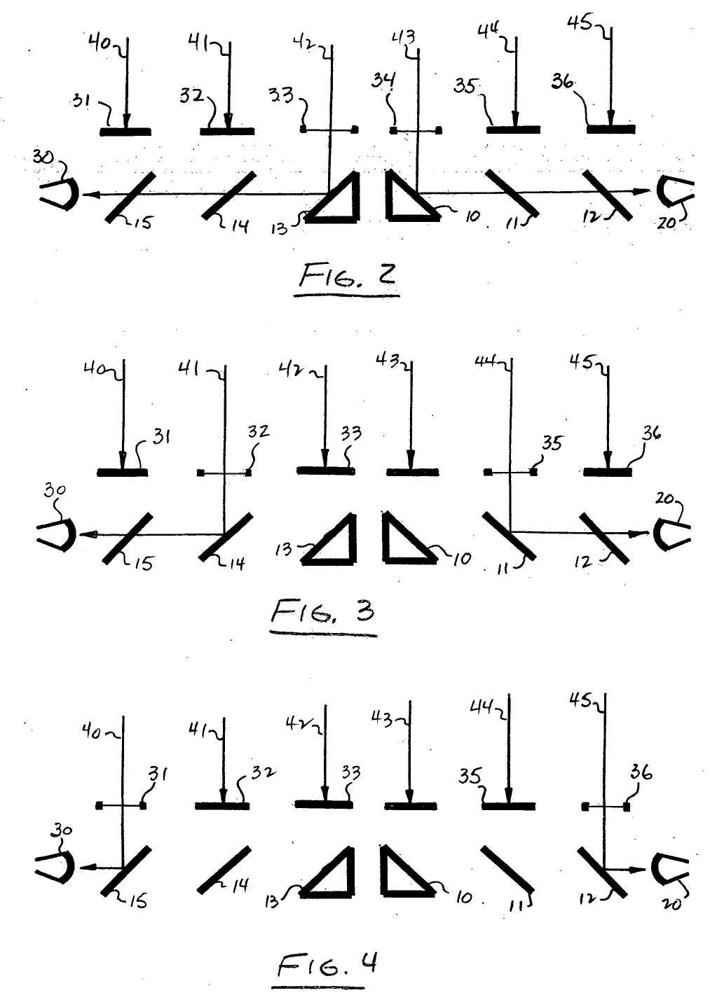

FIG. 2 is a diagram illustrating the mode of operation of the photography system of FIG. 1;

FIG. 3 is a diagram further illustrating the mode of operation of the photography system of FIG. 1;

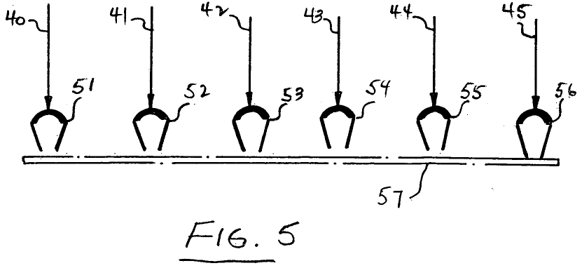

FIG. 4 is a diagram further illustrating the mode of operation of the photography system of FIG. 1;

FIG. 5 is a diagram illustrating an alternate embodiment of the invention particularly well-suited to producing 3D movies; and,

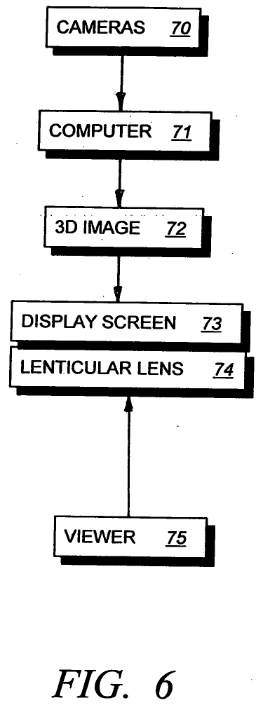

FIG. 6 is a block flow diagram illustrating the processing of camera images to produce a three-dimensional image that is shown on a display screen and, after the image passes through a lenticular lens, viewed.

Briefly, in accordance with the invention, I provide an improved system to produce three dimensional pictures of a selected viewable face of at least one object. The system includes at least one high speed digital camera positioned to receive light traveling along a path generally parallel to the viewable face of the object; a plurality of mirrors each positioned at a different location to receive light traveling away from the viewable face of the object and to reflect the light along the path toward the camera; a plurality of shutters each operatively associated with a different one of the mirrors to open in a selected sequence to permit light from the object to pass through the shutter to be reflected off the shutter's operatively associated mirror along the path toward the camera to produce an image in the camera; and, a computer program to receive images produced by the camera and produce a three dimensional photograph viewable through a lenticular lens.

Turning now to the drawings, which depict the presently preferred embodiments of the invention for purposes of description thereof and not by way of limitation of the invention, and in which like reference characters refer to corresponding elements throughout the several views, FIG. 1 illustrates a photography system for producing images that can be processed by a computer program to produce, for viewing through a lenticular lens, a three dimensional representation of a selected viewing face 51 of an object 50.

The system of FIG. 1 includes high speed digital cameras 20 and 30 and a plurality of shutters 31 to 36 each operatively associated with a different one of light-reflecting mirrors 10 to 15. Mirrors 11, 12, 14, 15 are, as will be see, substantially transparent to incident light impinging the rear of the mirrors.

In FIG. 1 each shutter 31 to 36 is closed.

When shutter 31 is open, light 40 traveling away from object 50 along a first path passes through shutter 31 and is reflected off the reflective face of mirror 15 to travel along a camera incident path of travel toward camera 30, which camera incident path of travel is generally parallel to the face 51 of object 50 and perpendicular to said first path that the light 40 traveled before being reflected by mirror 15.

When shutter 32 is open, light 41 traveling away from object 50 along a second path parallel to said first path (of light 40) passes through shutter 32 and is reflected off the reflective face of mirror 14 to travel along a camera incident path of travel to enter the rear of and pass through said transparent mirror 15 and toward camera 30, which camera incident path of travel is generally parallel to the face 51 of object 50 and perpendicular to said second path that the light 41 traveled before being reflected by mirror 14.

When shutter 33 is open, light 42 traveling away from object 50 along a third path parallel to said first and second paths (of light 40 and 41, respectively) passes through shutter 33 and is reflected off the reflective face of mirror 13 to travel along a camera incident path of travel to enter the rear of and pass through said transparent mirrors 14 and 15 and toward camera 30, which camera incident path of travel is generally parallel to the face 51 of object 50 and perpendicular to said third path that the light 42 traveled before being reflected by mirror 13.

When shutter 34 is open, light 43 traveling away from object 50 along a fourth path parallel to said first, second and third paths passes through shutter 34 and is reflected off the reflective face of mirror 10 to travel along a camera incident path of travel to enter the rear of and pass through transparent mirrors 11 and 12 and toward camera 20, which camera incident path of travel is generally parallel to the face 51 of object 50 and perpendicular to said fourth path that the light 43 traveled before being reflected by mirror 10.

When shutter 35 is open, light 44 traveling away from object 50 along a fifth path parallel to said first, second, third, and fourth paths passes through shutter 35 and is reflected off the reflective face of mirror 11 to travel along a camera incident path of travel to enter the rear of and pass through transparent mirror 12 and toward camera 20, which camera incident path of travel is generally parallel to the face 51 of object 50 and perpendicular to said fifth path that the light 44 traveled before being reflected by mirror 11.

When shutter 36 is open, light 45 traveling away from object 50 along a sixth path parallel to said first, second, third, fourth and fifth paths passes through shutter 36 and is reflected off the reflective face of mirror 12 to travel along a camera incident path of travel toward camera 20, which camera incident path of travel is generally parallel to the face 51 of object 50 and perpendicular to said sixth path that the light 45 traveled before being reflected by mirror 12.

Any desired system can be provided to adjust the distance between one operative shutter-mirror pair 31-15 and another shutter-mirror pair 32-14. By way of example, and not limitation, shutter-mirror pairs 31-15, 32-14, 33-13 can be mounted in a first bellows 16 that permits the bellows to be expanded or contracted to adjust the distance between those shutter-mirror pairs in the manner indicated by arrows A. Shutter-mirror pairs 34-10, 35-11, 36-12 can be mounted in a second bellows 17 that can be expanded or contracted to permit the distance between those shutter-mirror pairs to be adjusted in the manner indicated by arrows B. In another embodiment of the invention, the shutter-mirror pairs are slidably mounted on a rail that is generally parallel to the selected face 15 of the object 50 being photographed, and each shutter-mirror pair can be slid along the rail to adjust the distance from the shutter-mirror pair to another shutter-mirror pair. The distance between each adjacent pair 31-15 and 32-14 is typically, but not necessarily, the same as the distance between another adjacent pair 32-14 and 33-13.

Cameras 20 and 30 can, in some instance where unusually high shutter speed is not required, be mechanical cameras. Cameras 20 and 30 are, however, preferably high speed digital cameras that can operate in the range of sixty to ten thousand frames per second, preferably in the range of sixty to five thousand frames per second. One advantage of utilizing high speed digital cameras is that the cameras can readily electronically compensate for light attenuation that occurs when light reflected from mirror 13 passes through transparent mirrors 14 and 15, when light reflected from mirror 10 passes through mirrors 11 and 12, when light reflected from mirror 14 passes through mirror 15, and when light reflected from mirror 11 passes through mirror 12. One example of a high speed digital camera is the FASTCAM-X 1024 PCI offered by Photron USA, Inc. Of 9520 Padgett Street, Suite 110, San Diego, Calif. 92126-4446. The FASTCAM-X camera offers true 10 bit images up to a top speed in excess of 100,000 fps, and, offers mega pixel (1,024 by 1,024) resolution at 1,000 frames per second.

High speed electronic cameras are extremely sensitive and have almost no moving parts, which significantly reduces or eliminates problems resulting from mechanical failures and film defects. The high sensitivity of high speed electronic cameras enables the cameras to have a greater resolution with shorter exposure times, which is advantageous when faint images are being recorded. Further electronic cameras can record frames in continuous streak images, minimizing the amount of information that is lost between successive images.

Shutters 31 to 36 preferably are liquid crystal shutters that can be opened (clear) and closed (opaque) electronically. Mechanical shutters are not preferred because their upper limit is approximately one thousand frames per second. A liquid crystal shutter can be opened, or closed, in as little as 20 millionth of a second. For example, ferroelectric liquid crystals are marketed by Displaytech, Inc. Of 2602 Clover Basin Drive, Longmont, Colo., 80503.

The number of mirrors 10 to 15 used (or cameras in the event the embodiment of the invention in FIG. 5 is utilized) is in the range of two to sixteen, preferably four to eight.

In operation, the shutters in each shutter group 31-33 and 34-36 are opened in a desired sequence to permit cameras 20 and 30 to produce a sequence of images that can be combined by a software in a computer 71 to produce a desired 3D image 72 than can be formed on a display screen 73 to be viewed by an individual 75 through a lenticular lens 74 (FIG. 6). In an alternate embodiment of the invention, the images produced by cameras 20 and 30 are cut out and assembled side-by-side to produce a #d image that can be viewed through a lenticular lens.

FIGS. 2 to 4 illustrate one possible sequence of operation of the system of FIG. 1.

In FIG. 2, shutters 33 and 34 are simultaneously opened to permit light 42, 43 to be reflected off mirrors 13 and 10 into cameras 30 and 20, respectively. Light 42 reflected off mirror 13 passes along a camera incident path of travel through transparent mirrors 14 and 15 into camera 30. Light 43 reflected off mirror 10 passes along a camera incident path of travel through transparent mirrors 11 and 12 into camera 20. Shutters 31, 32, 35, 36 are closed, and light can not passes through these shutters. Only one shutter 31 to 33 is open at any given time. Only one shutter 34 to 36 is open at any given time.

In FIG. 3, shutters 33 and 34 have been closed electronically, and shutters 32 and 35 are simultaneously opened to permit light 41, 44 to be reflected off mirrors 14 and 11 into cameras 30 and 20, respectively. Light 41 reflected off mirror 14 passes along a camera incident path of travel through transparent mirror 15 into camera 30. Light 44 reflected off mirror 11 passes along a camera incident path of travel through transparent mirror 12 into camera 20. Shutters 31, 33, 34, 36 are closed, and light can not passes through these shutters.

In FIG. 4, shutters 32 and 35.have been closed electronically, and shutters 31 and 36 are simultaneously opened to permit light 40, 45 to be reflected off mirrors 15 and 12 into cameras 30 and 20, respectively. Light 40 reflected off mirror 15 passes along a camera incident path of travel into camera 30. Light 45 reflected off mirror 12 passes along a camera incident path of travel into camera 20. Shutters 31, 32, 35, 36 are closed, and light can not passes through these shutters.

The spacing between shutter-mirror pairs can vary as desired, but typically depends on the distance between object(s) 50 and mirrors 10 to 15. Ordinarily, the distance between two adjacent shutter-mirror pairs 31-15 and 32-14 is in the range of three-fourths inch to eight inches. The close spacing of shutter-mirror pairs is one reason that the embodiment of the invention in FIG. 1 is particularly useful. Cameras 20, 30 can be placed laterally from the mirrors 10 to 15 and need not be squeezed together side-by-side.

In the embodiment of the invention illustrated in FIG. 5, high speed digital cameras 51 to 56 are slidably mounted on a rail 57 that is generally parallel to the face 51 of the object 50 being photographed. This embodiment of the invention is advantageous when motion pictures are being recorded.

Having set forth the presently preferred embodiments of our invention in such terms as to enable those skilled in the art to make and use the invention, I claim:

1. A system for producing three dimensional pictures of a selected viewable face of at least one object, including
(a) at least one high speed digital camera positioned to receive light traveling along a path generally parallel to the viewable face of the object;
(b) a plurality of mirrors each positioned at a different location to receive light traveling away from the viewable face of the object and to reflect the light along said path toward said camera;
(c) a plurality of shutters each operatively associated with a different one of said mirrors to open in a selected sequence to permit light from the object to pass through said shutter to be reflected off said shutter's operatively associated mirror along said path toward said camera to produce an image in said camera; and,
(d) a computer program to receive images produced by said camera and produce a three dimensional photograph viewable through a lenticular lens.
